(19) United States
(12) Patent Application Publication
(10) Pub. No.: US 2021/0398148 A1
(43) Pub. Date: Dec. 23, 2021

(54) ENTITY PRESENCE INTERFACE

(71) Applicant: BANK OF AMERICA CORPORATION, Charlotte, NC (US)

(72) Inventors: Joseph Benjamin Castinado, North Glenn, CO (US); Lee Barry Frantz, Souderton, PA (US); Lee Ann Proud, Ponte Vedra, FL (US); Ann Ta, Scottsdale, AZ (US)

(73) Assignee: BANK OF AMERICA CORPORATION, Charlotte, NC (US)

(21) Appl. No.: 16/905,449

(22) Filed: Jun. 18, 2020

(51) Int. Cl. G06Q 30/02; G06Q 20/32

(52) U.S. Cl. CPC G06Q 30/0201; G06Q 20/3224; G06Q 30/0205

(57) ABSTRACT

Embodiments of the invention are directed to a system, method, or computer program product for an entity presence interface for identification and tracking of mobile entity presence effectiveness. In this way, the system identifies entity interactions at mobile entity presence locations and subsequently identifies resource generation from the mobile entity presence locations. With this, the system generates a presence resource generation metric that can be compared across various mobile locations for entity review and selection of effective mobile locations for entity presence.

### BACKGROUND

For typical mobile resource interactions, an application on a mobile device may be used to complete resource distributions. However, these mobile devices are not architecturally designed for resource processing, as such access to and potential misappropriation of the device is possible. Furthermore, currently there is no tracking or monitoring of these resource processing locations for entities. As such, a need exists for an entity presence interface for tracking and monitoring of resource generation at mobile locations.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In some embodiments, the invention provides an entity presence interface providing the entity with information about resource generation for entity mobile presence locations, current customer clustering, and predictive analytics. In some embodiments, the invention provides an entity presence interface for identification and tracking of mobile entity presence effectiveness. In this way, the system identifies entity interactions at mobile entity presence locations and subsequently identifies resource generation from the mobile entity presence locations. With this, the system generates a presence resource generation metric that can be compared across various mobile locations for entity review and selection of effective mobile locations for entity presence.

In this way, the invention identifies entity customer interactions with the entity, the location of those interactions, and the products/services purchased during the interactions. The system may track entity mobile location presence, such as at a tradeshow, roadshow, conference, vehicle, or the like. The system may also identify the touch points with customers at those locations such as resource interactions and the like to generate a mobile entity presences effectiveness metric. This reviews the entity resource requirements and logistic requirements for traveling to and staying at the mobile location for the entity. Comparing this with the resource generation and/or customer touch points from the mobile entity presence may generate an effectiveness metrics scoring the value of traveling to the mobile location.

Furthermore, the system may present the effectiveness metrics to the user for the location and the time of year associated with that location from the historic entity presence. Furthermore, the system may be able to predict effectiveness metrics for various other locations based on location data, competitor data, and the like.

Along with the effectiveness metrics, the system generates and provides customer cluster matrix that illustrate a clustering of the entity customers. Using this data the system may be able to target contact points for priority customers.

Embodiments of the present invention address these and/or other needs by providing an innovative system, method and computer program product for an entity presence interface, the invention comprises: identifying historic interactions with an entity comprising resource exchanges; plotting a geographic location of each of the historic interactions with the entity comprising resource exchange; identifying the historic interactions that occur at a mobile entity location; generating mobile entity presence metrics for each mobile location; presenting the mobile entity presence metrics and a customer cluster matrix to a user device; and generating mobile location selections and calendaring for entity mobile location presence.

In some embodiments, generating the mobile entity presence metrics for each mobile location further comprises generating the mobile entity presence metrics for entity historic mobile locations and a prediction of other mobile locations based on competitor presence at the other mobile locations.

In some embodiments, generating the mobile entity presence metrics for each mobile location comprises comparing resource generation at the mobile location compared to resource expensed for travel to the mobile location.

In some embodiments, the mobile entity presence metrics identifies direct resource generation and indirect resource generation from entity presence at the mobile location, wherein direct resource generation comprises direct interaction with a customer at the mobile location and indirect resource generation comprises identification of future interactions from one or more customers at the mobile location.

In some embodiments, identifying historic interactions with an entity comprising resource exchanges further comprises identifying transactions between a customer and the entity and a location associated with the transactions.

In some embodiments, plotting the geographic location of each of the historic interactions with the entity comprising resource exchange further comprises generation of the customer cluster matrix for display with the mobile entity presence metrics.

In some embodiments, the mobile entity locations are geographic locations other than an entity primary geographical place of business.

In some embodiments, a mobile resource interaction device performs functions of a point-of-transaction device to complete a transfer of resources from a customer to the user in exchange for products or services provided by the user to the customer at the mobile location.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an entity presence interface system environment, in accordance with one embodiment of the present invention;

FIG. 2 provides a high level process flow for generating the entity presence interface, in accordance with one embodiment of the present invention; and

FIG. 3 provides a process flow for implementation of the entity presence interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any merchant or merchant associate interacting with a customer. The user may interact with a customer, such as a customer purchasing a product or service from a merchant. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “technology activity” or “resource distribution” may include a transaction for a product or service from a merchant. A “transaction” or “resource distribution” refers to any communication between a user and a customer to transfer funds for the purchasing or selling of a product or service. A transaction may refer to a purchase of goods or services, a return of goods or services, a payment transaction, a credit transaction, or other interaction involving an account. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, the mobile distribution device may be a point-of-transaction device (POT) may be or include a merchant machine and/or server and/or may be or include the mobile device of the user may function as a point of transaction device. The embodiments described herein may refer to the use of a transaction, transaction event or point of transaction event to trigger the steps, functions, routines or the like described herein. In various embodiments, occurrence of a transaction triggers the sending of information such as alerts and the like. As used herein, a “bank account” refers to a credit account, a debit/deposit account, or the like. Although the phrase “bank account” includes the term “bank,” the account need not be maintained by a bank and may, instead, be maintained by other financial institutions. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to a technology activity such as an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a user device, and in yet other embodiments, it refers to both a customer device and a user device interacting to perform a transaction. For example, in one embodiment, the point-of-transaction device refers to the user's mobile device configured to communicate with a customer device, whereas in other embodiments, the point-of-transaction device refers to a terminal configured to communicate with a user's mobile device and customer's mobile device, and in yet other embodiments, the point-of-transaction device refers to both.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

A “mobile location” as used herein may be a geographical location that is not a location where an entity or merchant has a regular presence. The mobile location may be the location of a tradeshow, entity vehicle (such as a food truck), convention, or other location other than the entity primary geographical place of business.

In some embodiments, the invention provides an entity presence interface providing the entity with information about resource generation for entity mobile presence locations, current customer clustering, and predictive analytics. In some embodiments, the invention provides an entity presence interface for identification and tracking of mobile entity presence effectiveness. In this way, the system identifies entity interactions at mobile entity presence locations and subsequently identifies resource generation from the mobile entity presence locations. With this, the system generates a presence resource generation metric that can be compared across various mobile locations for entity review and selection of effective mobile locations for entity presence.

In this way, the invention identifies entity customer interactions with the entity, the location of those interactions, and the products/services purchased during the interactions. The system may track entity mobile location presence, such as at a tradeshow, roadshow, conference, vehicle, or the like. The system may also identify the touch points with customers at those locations such as resource interactions and the like to generate a mobile entity presences effectiveness metric. This reviews the entity resource requirements and logistic requirements for traveling to and staying at the mobile location for the entity. Comparing this with the resource generation and/or customer touch points from the mobile entity presence may generate an effectiveness metrics scoring the value of traveling to the mobile location.

Furthermore, the system may present the effectiveness metrics to the user for the location and the time of year associated with that location from the historic entity presence. Furthermore, the system may be able to predict effectiveness metrics for various other locations based on location data, competitor data, and the like.

Along with the effectiveness metrics, the system generates and provides customer cluster matrix that illustrate a clustering of the entity customers. Using this data the system may be able to target contact points for priority customers.

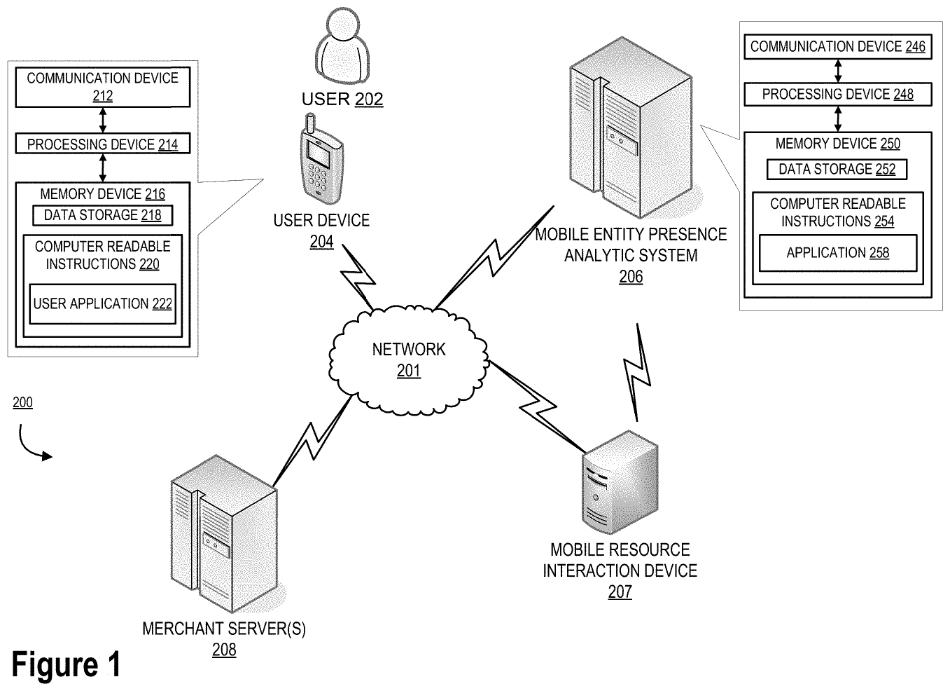

FIG. 1 provides an entity presence interface system environment 200, in accordance with one embodiment of the present invention. FIG. 1 provides the system environment 200 for which the distributive network system with specialized data feeds. FIG. 1 provides a unique system that includes specialized servers and system communicably linked across a distributive network of nodes required to perform the functions described herein.

As illustrated in FIG. 1, the merchant server 208 is operatively coupled, via a network 201 to the user device 204, mobile resource interaction device 207, and to the mobile entity presence analytic system 206. In this way, the merchant server 208 can send information to and receive information from the user device 204, mobile resource interaction device 207, and the mobile entity presence analytic system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity associated with a merchant that has one or more user devices 204. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the mobile entity presence analytic system 206, the merchant server 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the mobile entity presence analytic system 206.

As further illustrated in FIG. 1, the mobile entity presence analytic system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant server 208, the mobile resource interaction device 207, the point-of-transaction device 205, and the user device 204. As such, the communication device 246 generally comprises a modem, server, or other device for communicating with other devices on the network 201.

As further illustrated in FIG. 1, the mobile entity presence analytic system 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the mobile entity presence analytic system 206 the memory device 250 stores an application 258. In one embodiment of the invention, the application 258 may associate with applications having computer-executable program code. Furthermore, the mobile entity presence analytic system 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more merchant server 208, mobile resource interaction device 207, and/or user device 204.

As illustrated in FIG. 1, the mobile resource interaction device 207 is connected to the merchant server 208, user device 204, and mobile entity presence analytic system 206. The mobile resource interaction device 207 has the same or similar components as described above with respect to the user device 204 and the mobile entity presence analytic system 206. While only one mobile resource interaction device 207 is illustrated in FIG. 1, it is understood that multiple mobile resource interaction device 207 may make up the system environment 200. The mobile resource interaction device 207 may be associated with one or more financial institutions, entities, or the like.

In some embodiments, the mobile resource interaction device 207 may be a POT device that includes an interactive computer terminal that is configured to initiate, perform, complete, and/or facilitate one or more transactions. The mobile resource interaction device 207 could be or include any device that a user or customer may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, the mobile resource interaction device 207 is operated in a public place (e.g., on a street corner, at the doorstep of a private residence, in an open market, at a public rest stop, and the like). In other embodiments, the mobile resource interaction device 207, is additionally or alternatively operated in a place of business (e.g., in a retail store, post office, banking center, grocery store, factory floor, and the like). In some embodiments, the mobile resource interaction device 207 is operated in a mobile place of business such as in a vehicle or at a tradeshow.

As illustrated in FIG. 1, the mobile resource interaction device 207 device may generally comprises a reading device, a communication device, a processing device, and a memory device. The reading device is operatively coupled to the processing device, communication device, and the memory device. The mobile resource interaction device 207 device may include a reader device to receive payment account information from the customer through the device, mobile application server, financial institution systems, and/or other potential payment devices.

Such a reader device may include, but is not limited to a magnetic strip reader, a barcode scanner, a radio frequency (RF) reader, a character recognition device, a magnetic ink reader, an NFC reading device, a processor for interpreting codes presented over an electrical or optical medium, a biometric reader, a wireless receiving device, and/or the like. In some embodiments, the reading device receives information that may be used to identify the customer's payment account from a payment device and may communicate via the communication device over a network, to other systems such as, but not limited to the mobile application server, financial institution systems, and/or the user device. As such, the communication device generally comprises a modem, server, or other device for communicating with other devices on the network 201.

In some embodiments, the mobile resource interaction device 207 is or includes an interactive computer terminal that is configured to initiate, perform, complete, and/or facilitate one or more transactions. The mobile resource interaction device 207 could be or include any means that a customer may use to perform a transaction with a user, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, the mobile resource interaction device 207 is operated in a public place (e.g., on a street corner, at the doorstep of a private residence, in an open market, at a public rest stop, or the like). In other embodiments, the mobile resource interaction device 207 is additionally or alternatively operated in a place of business (e.g., in a retail store, post office, banking center, grocery store, factory floor, or the like).

The mobile resource interaction device 207 as discussed herein may include any point-of-transaction device mechanisms for completing a transaction. As such, the mobile resource interaction device 207 may be able perform a sale, an account balance check, a reward transfer, and account money transfer, a user opening up a bank application on his mobile device or computer, and/or the like.

The mobile resource interaction device 207 may receive an authorization request from a customer. The authorization request may include providing a PIN number input, touch connection, and/or unique code identification. In some embodiments, the authorization request may be a touch connection that may include a mat located at the mobile resource interaction device 207 such that the customer may place a device on the mat to authorize that the customer is wishing to transact with the merchant. In some embodiments, the authorization request may provide a unique code identification such as a NFC token, voice, text, and/or the like to authorize the communication. The authorization request may be a unique code identification presented to communicate that with the mobile resource interaction device 207. Unique code identifications may include, in some embodiments, various universal product codes (UPC codes), numbers associated with a UPC code, QR codes, and/or the like. In some embodiments, the UPC code may comprise a 12 digit code and include between a 6 to 10 digit company prefix. The authorization request may comprise UPC codes such as those assigned by the GS1 US (formerly the Uniform Code Council) and/or the like.

As illustrated in FIG. 1, the merchant server 208 is connected to the mobile resource interaction device 207, user device 204, and mobile entity presence analytic system 206. The merchant server 208 may be associated with the mobile entity presence analytic system 206. The merchant server 208 has the same or similar components as described above with respect to the user device 204 and the mobile entity presence analytic system 206. While only one merchant server 208 is illustrated in FIG. 1, it is understood that multiple merchant server 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The merchant server 208 may generally include a processing device communicably coupled to devices as a memory device, output devices, input devices, a network interface, a power source, one or more chips, and the like. The merchant server 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the merchant server 208 described herein.

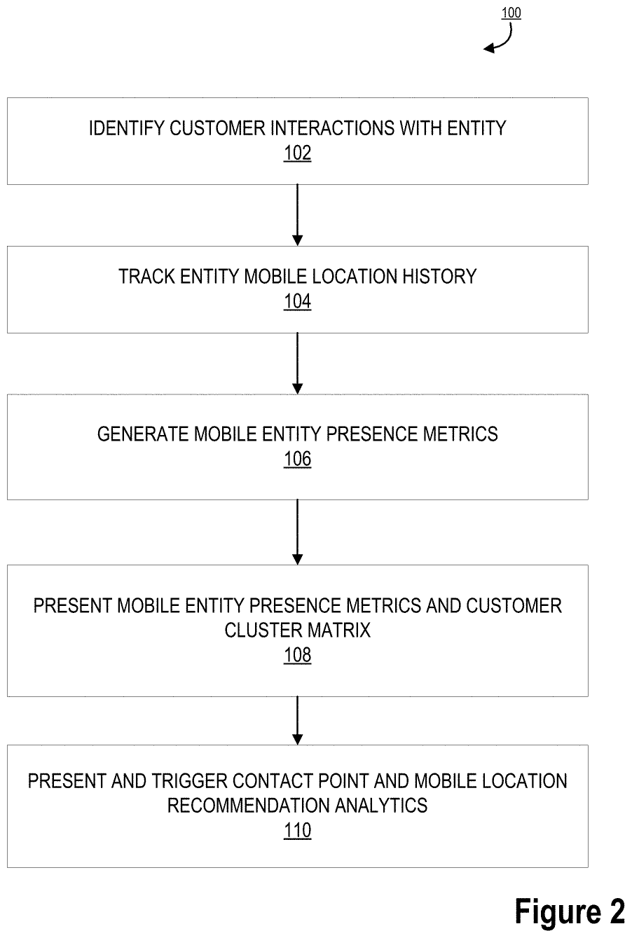

FIG. 2 provides a high level process flow for generating the entity presence interface 100, in accordance with one embodiment of the present invention. As illustrated in block 102, the process 100 is initiated by identifying customer interactions with the entity. In this way, the system may identify transactions between customers and the entity including the time and location of the transaction as well as products and/or services associated with the transaction. The system stores the data for processing and analysis for mobile entity presence metrics.

As illustrated in block 104, the process 100 continues by tracking the entity mobile location history and correlate that the customer interactions. As such, the system may identify a mobile location of the entity for a tradeshow, convention, vehicle, or the like at a mobile location. The system may track the customer interactions during the mobile location visit as direct interactions. In some embodiments, the system may track interactions with customers via other channels from the location of the mobile visit after the mobile visit as an indirect contact.

Using the customer interaction data and the entity mobile location tracking, the system may generate a mobile entity presence metrics, as illustrated in block 106. This metric correlates the resources generated from the mobile presence compared to the resources expensed and used for traveling to the mobile location. The resources generated from the mobile presence may be direct transactions at the mobile location and indirect transactions that occur from customers at the mobile location after the mobile presence at the mobile location. As such, the system may identify a net resource generation from the mobile presence.

Furthermore, using the metrics the system may be able to predict resource generation for various locations based on entity historic travel to the location, based on competitor data, and based on customer clustering. Using these aspects the system may predict and provide the user with dates and times to visit specific geographical locations for maximization of a net resource generation for a mobile presence.

As illustrated in block 108, the process 100 continues by presenting the mobile entity presence metrics and customer cluster matrix to a user. As such, the system may provide an interface with entity presence metrics illustrating a resource generation for various locations for user or entity travel to the location for a period of time within a specific time during the year. Furthermore, the system may provide a cluster matrix to illustrate geographical areas associated with the entity customers for prediction and contact point focusing.

As illustrated in block 110, the process is finalized by presenting and triggering a contact point and mobile location recommendation analytics to the user for calendaring of specific contact point and mobile location visitation determinations.

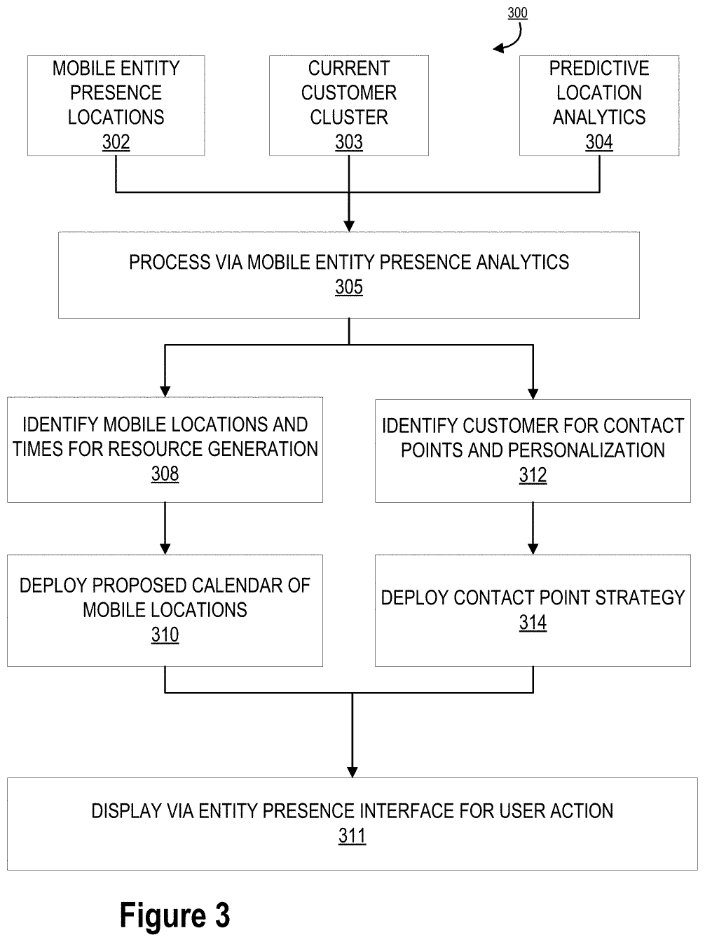

FIG. 3 provides a process flow for implementation of the entity presence interface 300, in accordance with one embodiment of the present invention. The process 300 is initiated by utilizing mobile entity presence locations 302, current customer clustering 303, and predictive location analytics 304 for processing via the mobile entity presence analytics, as illustrated in block 305.

In some embodiments, the system may identify the mobile entity presence locations 302. In this way, the system may identify the locations of the entity, both physical locations of the entity and mobile locations of the entity. In some embodiments, current customer clustering 303 comprises a clustering analysis of customers of the entity via geographic location. As such, providing an indication of locations of customers such as those online customers or the like. Finally, predictive location analytics 304 reviews the entity competitors in combination with the customer clustering to predict and identify one or more locations that the entity has not visited via a mobile location and predicts the entity resource generation for the location.

Next, as illustrated in block 305, the process 300 continues by processing the data received or generated via the mobile entity presence analytics. In this way, the system may further refine data points and create one or more mapping and calendaring interfaces for the user.

As illustrated in block 308, the processing from the mobile entity presence analytics may identify mobile locations and times for resource generation maximization for the entity. As illustrated in block 310, the process 300 continues by deploying a proposed calendar of mobile locations for the entity to select from for the upcoming dates. As such, these locations may have the best cost compared to resource generation ratio for both direct and indirect customer interactions. This calendaring is then displayed via the entity presence interface for user action, as illustrated in block 311.

Referring back to block 312 of FIG. 3, the process 300 utilizes the processing via the mobile entity presence analytics in order to identify customers for contact points and personalization. In this way, the system utilizes current customer clustering to illustrate density of customer locations in order to allow for deployment of contact point strategies for the entity, as illustrated in block 314. The clustering and contact point strategies are then displayed via the entity presence interface for user action, as illustrated in block 311.

In some embodiments, the invention provides an entity presence interface providing the entity with information about resource generation for entity mobile presence locations, current customer clustering, and predictive analytics. In some embodiments, the invention provides an entity presence interface for identification and tracking of mobile entity presence effectiveness. In this way, the system identifies entity interactions at mobile entity presence locations and subsequently identifies resource generation from the mobile entity presence locations. With this, the system generates a presence resource generation metric that can be compared across various mobile locations for entity review and selection of effective mobile locations for entity presence.

In this way, the invention identifies entity customer interactions with the entity, the location of those interactions, and the products/services purchased during the interactions. The system may track entity mobile location presence, such as at a tradeshow, roadshow, conference, vehicle, or the like. The system may also identify the touch points with customers at those locations such as resource interactions and the like to generate a mobile entity presences effectiveness metric. This reviews the entity resource requirements and logistic requirements for traveling to and staying at the mobile location for the entity. Comparing this with the resource generation and/or customer touch points from the mobile entity presence may generate an effectiveness metrics scoring the value of traveling to the mobile location.

Furthermore, the system may present the effectiveness metrics to the user for the location and the time of year associated with that location from the historic entity presence. Furthermore, the system may be able to predict effectiveness metrics for various other locations based on location data, competitor data, and the like.

Along with the effectiveness metrics, the system generates and provides customer cluster matrix that illustrate a clustering of the entity customers. Using this data the system may be able to target contact points for priority customers.

Embodiments of the present invention address these and/or other needs by providing an innovative system, method and computer program product for an entity presence interface, the invention comprises: identifying historic interactions with an entity comprising resource exchanges; plotting a geographic location of each of the historic interactions with the entity comprising resource exchange; identifying the historic interactions that occur at a mobile entity location; generating mobile entity presence metrics for each mobile location; presenting the mobile entity presence metrics and a customer cluster matrix to a user device; and generating mobile location selections and calendaring for entity mobile location presence.

In some embodiments, generating the mobile entity presence metrics for each mobile location further comprises generating the mobile entity presence metrics for entity historic mobile locations and a prediction of other mobile locations based on competitor presence at the other mobile locations.

In some embodiments, generating the mobile entity presence metrics for each mobile location comprises comparing resource generation at the mobile location compared to resource expensed for travel to the mobile location.

In some embodiments, the mobile entity presence metrics identifies direct resource generation and indirect resource generation from entity presence at the mobile location, wherein direct resource generation comprises direct interaction with a customer at the mobile location and indirect resource generation comprises identification of future interactions from one or more customers at the mobile location.

In some embodiments, identifying historic interactions with an entity comprising resource exchanges further comprises identifying transactions between a customer and the entity and a location associated with the transactions.

In some embodiments, plotting the geographic location of each of the historic interactions with the entity comprising resource exchange further comprises generation of the customer cluster matrix for display with the mobile entity presence metrics.

In some embodiments, the mobile entity locations are geographic locations other than an entity primary geographical place of business.

In some embodiments, a mobile resource interaction device performs functions of a point-of-transaction device to complete a transfer of resources from a customer to the user in exchange for products or services provided by the user to the customer at the mobile location.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for an entity presence interface, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
identify historic interactions with an entity comprising resource exchanges;
plot a geographic location of each of the historic interactions with the entity comprising resource exchange;
identify the historic interactions that occur at a mobile entity location;
generate mobile entity presence metrics for each mobile location;
present the mobile entity presence metrics and a customer cluster matrix to a user device; and
generate mobile location selections and calendaring for entity mobile location presence.

2. The system of claim 1, wherein generating the mobile entity presence metrics for each mobile location further comprises generating the mobile entity presence metrics for entity historic mobile locations and a prediction of other mobile locations based on competitor presence at the other mobile locations.

3. The system of claim 1, wherein generating the mobile entity presence metrics for each mobile location comprises comparing resource generation at the mobile location compared to resource expensed for travel to the mobile location.

4. The system of claim 1, wherein the mobile entity presence metrics identifies direct resource generation and indirect resource generation from entity presence at the mobile location, wherein direct resource generation comprises direct interaction with a customer at the mobile location and indirect resource generation comprises identification of future interactions from one or more customers at the mobile location.

5. The system of claim 1, wherein identifying historic interactions with an entity comprising resource exchanges further comprises identifying transactions between a customer and the entity and a location associated with the transactions.

6. The system of claim 1, wherein plotting the geographic location of each of the historic interactions with the entity comprising resource exchange further comprises generation of the customer cluster matrix for display with the mobile entity presence metrics.

7. The system of claim 1, wherein the mobile entity locations are geographic locations other than an entity primary geographical place of business.

8. The system of claim 1, wherein a mobile resource interaction device performs functions of a point-of-transaction device to complete a transfer of resources from a customer to the user in exchange for products or services provided by the user to the customer at the mobile location.

9. A computer program product for an entity presence interface, the computer program product comprising at least one non-transitory computer-readable medium having computer-readable program code portions embodied therein, the computer-readable program code portions comprising:
an executable portion configured for identifying historic interactions with an entity comprising resource exchanges;
an executable portion configured for plotting a geographic location of each of the historic interactions with the entity comprising resource exchange;
an executable portion configured for identifying the historic interactions that occur at a mobile entity location;
an executable portion configured for generating mobile entity presence metrics for each mobile location;
an executable portion configured for presenting the mobile entity presence metrics and a customer cluster matrix to a user device; and
an executable portion configured for generating mobile location selections and calendaring for entity mobile location presence.

10. The computer program product of claim 9, wherein generating the mobile entity presence metrics for each mobile location further comprises generating the mobile entity presence metrics for entity historic mobile locations and a prediction of other mobile locations based on competitor presence at the other mobile locations.

11. The computer program product of claim 9, wherein generating the mobile entity presence metrics for each mobile location comprises comparing resource generation at the mobile location compared to resource expensed for travel to the mobile location.

12. The computer program product of claim 9, wherein the mobile entity presence metrics identifies direct resource generation and indirect resource generation from entity presence at the mobile location, wherein direct resource generation comprises direct interaction with a customer at the mobile location and indirect resource generation comprises identification of future interactions from one or more customers at the mobile location.

13. The computer program product of claim 9, wherein identifying historic interactions with an entity comprising resource exchanges further comprises identifying transactions between a customer and the entity and a location associated with the transactions.

14. The computer program product of claim 9, wherein plotting the geographic location of each of the historic interactions with the entity comprising resource exchange further comprises generation of the customer cluster matrix for display with the mobile entity presence metrics.

15. The computer program product of claim 9, wherein a mobile resource interaction device performs functions of a point-of-transaction device to complete a transfer of resources from a customer to the user in exchange for products or services provided by the user to the customer at the mobile location.

16. A computer-implemented method for an entity presence interface, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying historic interactions with an entity comprising resource exchanges;
plotting a geographic location of each of the historic interactions with the entity comprising resource exchange;
identifying the historic interactions that occur at a mobile entity location;
generating mobile entity presence metrics for each mobile location;
presenting the mobile entity presence metrics and a customer cluster matrix to a user device; and
generating mobile location selections and calendaring for entity mobile location presence.

17. The computer-implemented method of claim 16, wherein generating the mobile entity presence metrics for each mobile location further comprises generating the mobile entity presence metrics for entity historic mobile locations and a prediction of other mobile locations based on competitor presence at the other mobile locations.

18. The computer-implemented method of claim 16, wherein generating the mobile entity presence metrics for each mobile location comprises comparing resource generation at the mobile location compared to resource expensed for travel to the mobile location.

19. The computer-implemented method of claim 16, wherein the mobile entity presence metrics identifies direct resource generation and indirect resource generation from entity presence at the mobile location, wherein direct resource generation comprises direct interaction with a customer at the mobile location and indirect resource generation comprises identification of future interactions from one or more customers at the mobile location.

20. The computer-implemented method of claim 16, wherein identifying historic interactions with an entity comprising resource exchanges further comprises identifying transactions between a customer and the entity and a location associated with the transactions.
